(19) United States
(12) Patent Application Publication
(10) Pub. No.: US 2012/0089467 A1
(43) Pub. Date: Apr. 12, 2012

(54) SYSTEM AND METHOD OF CAPTURING POINT-OF-SALE DATA AND PROVIDING REAL-TIME ADVERTISING CONTENT

(75) Inventor: Antonio COMPARELLI, Thornhill (CA)

(73) Assignee: RT7 INCORPORATED, Toronto (CA)

(21) Appl. No.: 12/899,014

(22) Filed: Oct. 6, 2010

(51) Int. Cl. G06Q 30/00; G06K 19/06

(52) U.S. Cl. 705/16; 235/494; 235/375

(57) ABSTRACT

A tap device is provided that monitors data communications with a point-of-service terminal device and communicates with remote servers that are associated with an external network, a local server that is associated with an internal network and a display for displaying point-of-purchase promotional media. The tap device includes a monitoring device that monitors communication lines of the point-of-service terminal device for data packets having sales transaction data. The tap device includes a trigger database having entries with pre-stored digital message trigger data elements and a processor that communicates with the monitoring device to receive the sales transaction data. The processor generates instructions to search the entries of the trigger database for a match between the pre-stored digital message trigger data elements and the sales transaction data. The tap device includes an engine that releases selected digital messages to the display upon receiving a signal from the processor identifying a match.

### FIELD OF THE INVENTION

The invention relates to systems and methods of delivering content. More particularly, the invention relates to systems and methods of delivering content at a point-of-service (“POS”) terminal. More particularly, the invention relates to systems and methods of delivering content, such as digital messages, in real-time at a POS terminal in response to purchase transaction data.

### BACKGROUND OF THE INVENTION

Discount coupons are well-known in the retail goods industry to promote the sale of specific goods to consumers. Known coupon or promotion distribution is performed using mass distribution techniques. These techniques do not efficiently target coupon delivery to desired consumers, such as consumers most likely to remit the discount coupons. Distribution techniques have evolved to trigger coupon delivery based on consumer behavior. For example, known systems deliver proprietary digital content, such as printed sales receipts, to consumers based on information obtained at point-of-service (“POS”) terminals. Furthermore, known systems use proprietary formats to deliver the proprietary digital content to consumers.

As a result, known systems restrict a retailer's ability to display non-proprietary digital content to consumers. To overcome this deficiency, existing systems employ extensive software or hardware modifications to display the non-proprietary digital content. Alternatively, the non-proprietary digital content may be converted to a proprietary format before display on existing systems. In the absence of software modification, hardware modification or data conversion, known systems are incapable of displaying non-proprietary digital content. Thus, retailers are unable to display non-proprietary digital content at an expense of foregoing media revenue and/or advertising revenue. What is needed is a system and method of displaying all types of digital content at POS terminals, without needing to modify the POS terminals.

### SUMMARY OF THE INVENTION

The invention advantageously provides a method and system for automatically delivering digital messages for presentation to consumers on digital displays, without any modification of existing point-of-sale systems or electronic cash registers.

According to one embodiment, a tap device is provided that monitors data communications with a point-of-service terminal device. The tap device communicates with remote servers that are associated with an external network, a local server that is associated with an internal network and a display for displaying point-of-purchase promotional media. The tap device includes a monitoring device that monitors communication lines of the point-of-service terminal device for data packets having sales transaction data. The tap device includes a trigger database having entries with pre-stored digital message trigger data elements and a processor that communicates with the monitoring device to receive the sales transaction data. The processor generates instructions to search the entries of the trigger database for a match between the pre-stored digital message trigger data elements and the sales transaction data. The tap device includes an engine that releases selected digital messages to the display upon receiving a signal from the processor identifying a match.

According to another embodiment, a point-of-sale system is provided in an environment having a plurality of stores that are associated with two or more organizations. The point-of-sale system includes a plurality of in-store networks that are associated with the plurality of stores and with at least one of the two or more organizations. The plurality of in-store networks include a tap device that monitors data communications with a corresponding point-of-service terminal device. The tap device assigns a unique identifier to sales transaction data associated with the tap device and the corresponding in-store network. An information server is provided to communicate with the tap device to obtain the sales transaction data and the unique identifier. The information server includes an aggregation device that aggregates the sales transaction data associated with the two or more organizations based on the unique identifier and a segregation device that separates the sales transaction data associated with the two or more organizations based on the unique identifier. The information server also includes a control device that enables the two or more organizations to control access to the corresponding sales transaction data. A digital message server is provided to communicate with the information server and the tap device, the digital message server delivering digital messages to the tap device for display to users.

According to yet another embodiment, a method is provided of automatically delivering digital messages to consumers at a point-of-sale location, without modifying existing point-of-service terminal devices. The method includes monitoring data transmitted between the point-of-service terminal device and an output device for predefined unique markers and capturing the data having the predefined unique markers using a tap device. The captured data is compared against digital message trigger data elements stored in a trigger database to identify a match between the captured data and the digital message trigger data elements. If a match is identified, selected digital messages are released to a display associated with the tap device. The selected digital images include a plurality of audio or video file types.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 illustrates a system diagram according to one embodiment of the invention;

FIG. 2 illustrates a system diagram according to a second embodiment of the invention; and

FIG. 3 illustrates a flow chart for automatically displaying digital messages to consumers at a point-of-service terminal, regardless of message format.

### DETAILED DESCRIPTION OF THE INVENTION

Retailers continue to seek ways to expand point-of-purchase promotional media opportunities. The present invention provides devices that add functionality to existing point-of-sale (“POS”) retail management systems, such as computer based POS terminals and electronic cash register systems, among other devices. The invention provides the additional functionality without modifying software or hardware components of these POS retail management systems. According to one embodiment, the invention displays point-of-purchase promotional media on digital displays integrated directly into the POS or electronic cash register systems.

POS retail management systems are used in various environments, including retail hard good environments, grocery environments, soft good environments, brown good environments and quick service environments, among other environments. POS retail management systems operate to manage inventory, process sales transactions, tender payment and record transactional activity, among performing other functions. POS retail management systems provide various output options, including generating printed sale receipts upon completion of sales transactions.

The invention provides a tap device positioned between the POS terminal and the output device, such a receipt printer, to passively gather or “wiretap” data transmitted between these devices. The tap device may be removably coupled to these devices. Furthermore, the tap device does not modify the operation of or the interaction between the POS terminal and the output device, even during a tap device failure. In other words, the tap device streams data between the POS terminal and the output device, regardless of its operation state.

According to one embodiment, the output device may be coupled to the POS terminal through an interface, such as a serial port, a parallel port or a Universal Serial Bus (“USB”) port, among other interfaces. If the POS terminal outputs data in serial format to the output device, the interface may include a serial-to-USB data converter that sends monitored data in serial form through the USB interface to the tap device. If the POS terminal outputs data in a serial format via USB port to the output device, the interface may include a USB data tap that monitors the serial data transmitted to the tap device. The tap device may include a video connection that displays digital messages to an in-store digital display.

While specific embodiments of the invention are discussed herein and are illustrated in the figures appended hereto, the invention encompasses a broader spectrum than the specific subject matter described and illustrated. As would be appreciated by those skilled in the art, the embodiments described herein provide but a few examples of the broad scope of the invention. There is no intention to limit the scope of the invention only to the embodiments described.

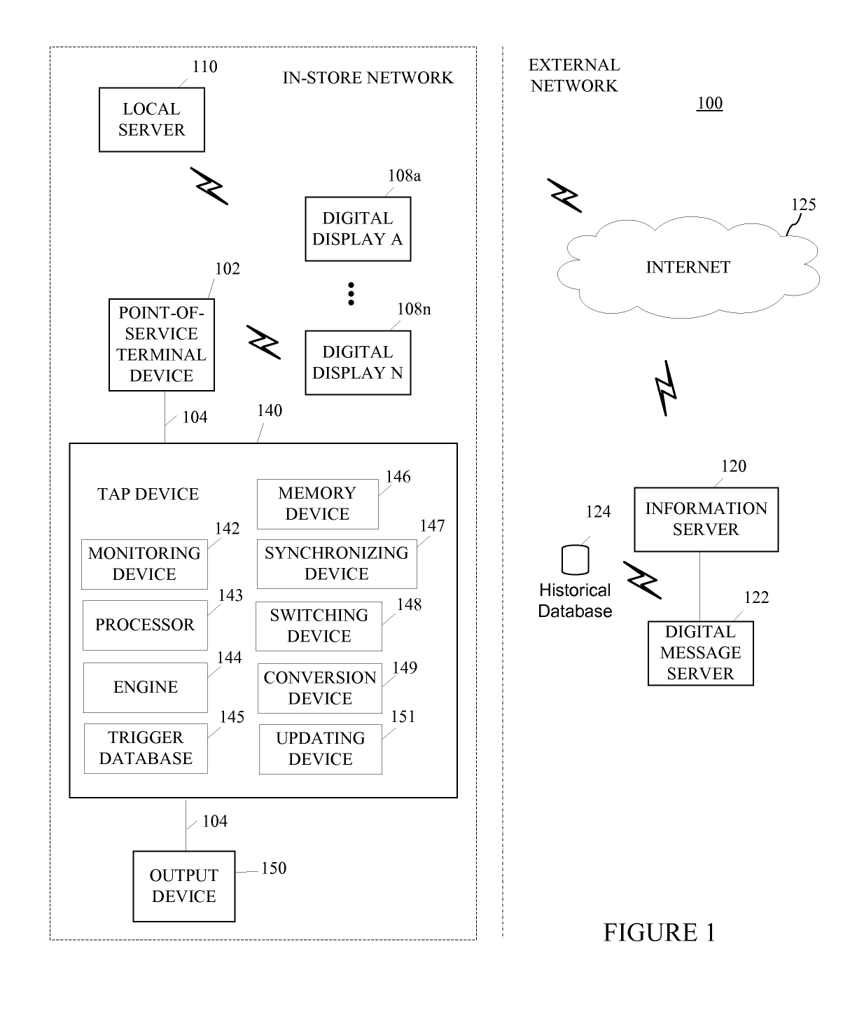

FIG. 1 illustrates an example of system architecture 100 according to one embodiment of the invention. The POS terminal 102 may be communicatively coupled to one or more local servers 110 and/or to one or more remote servers, including an information server 120 and a digital message server 122, among other servers. A historical database 124 may be provided to communicate with the remote servers to archive sales data, among other data. The POS terminal 102 may be communicatively coupled to the system architecture 100 via a wired network, a wireless network, or a combination of the foregoing and/or other networks, including the Internet 125. The POS terminal 102 may be coupled to an output device 150, such as a printer, imaging device or other output device. The tap device 140 may be positioned between the POS terminal 102 and the output device 150 to monitor and/or capture data, including sales transaction data, passing between these devices, among performing other functions.

The local server 110 and the remote servers are communicatively coupled to capture, store, and forward data communications to the POS terminal devices 102. According to one embodiment, the local server 110 may be an in-store server that stores sales receipt information, including product assigned identification codes, such as price look up (“PLU”) codes and stock keeping unit (“SKU”) codes, among other product codes. The local server 110 also may store information associated with product descriptions; inventory data, including product quantity amounts; purchase price data; payment method data; total value of the sale data, including sub-total and total amounts; transaction date; transaction time; transaction location, including store data and POS terminal device data; retail establishment type; and retail establishment categories; among other information.

The tap device 140 may be of modular construction to facilitate adding, deleting, updating and/or amending modules therein and/or features within modules. The modules may include hardware components, such as a monitoring device 142, a processor 143, an engine 144, a trigger database 145, a memory device 146, a switching device 147, a synchronizing device 148, a conversion device 149, an updating device 151, or other modules. It should be readily understood that a greater or lesser number of modules might be used. One skilled in the art will readily appreciate that the invention may be implemented using individual modules or a single module that incorporates the features of two or more separately described modules, among other configurations.

The tap device 140 may include a monitoring device 142 that monitors communication lines 104 for data signals, including sales transaction data, passing between the POS terminal 102 and the output device 150. According to one embodiment, the monitoring device 142 monitors data packets traversing the data lines 104. The data packets may include markers that uniquely identify data packet types. For example, the markers may include codes that correspond to predefined events, such as a start or termination of purchase transactions. The sales transaction data may include product identification codes; manufacturer information; product quantity amounts; purchase price data; payment method data; total value of the sale data; transaction location; retailer categories, including clothing retailer, shoe retailer, food retailer, among other retailer categories; product description information, including searching text provided in the product description (e.g., 100 oz. bottle of sun screen) obtained from the product identification codes.

The tap device 140 may include a processor 143 that communicates with the monitoring device 142 and generates instructions for performing selected actions upon receiving the codes. According to one embodiment, the selected actions may be performed in real-time. For example, the processor 143 may instruct an engine 144 located within the tap device 140 obtain the sales transaction data and to send preselected digital content to the digital displays 108a-108n (hereinafter referred to as “digital displays 108”), among performing other selected actions. The digital displays 108 may be positioned proximate to the corresponding POS terminals 102 to display the content to desired users.

The digital displays 108 may include any number of stand alone digital displays. Alternatively, the digital displays 108 may include digital displays associated with different types of devices, such as personal digital assistants (PDAs), mobile devices, cell phones, personal computers, laptops, among other devices that combine the functionality of one or more of the foregoing devices. The digital display 108 may be associated with devices that include processors, RAM, USB interfaces, telephone interfaces, satellite interface, microphones, speakers, a stylus, a computer mouse, a wide area network interface, a local area network interface, hard disks, wireless communication interfaces, a keyboard, a flat touch-screen display, and a display, among other components.

According to one embodiment, the digital displays 108 may include a touch-sensitive display screen, a handset, speakers and input buttons, among other features. Selected functions may be implemented on the digital displays 108 by positioning an indicator over selected icons and manipulating an input receiving device such as a touch-sensitive display screen, a mouse, a keyboard, a voice recognition system or other input receiving devices. The digital displays 108 may include a video input device to permit audio-visual communications. The digital displays 108 may communicate with the POS terminal 102, the local server 110, the information server 120, the digital message server 122 and/or other systems.

Upon receiving the codes and the sales transaction data, the processor 143 may access a trigger database 145 having pre-stored digital message trigger data elements. The digital message trigger data elements include product identification codes; manufacturer information; product quantity amounts; purchase price data; payment method data; total value of the sale data; transaction location; retailer categories, including clothing retailer, shoe retailer, food retailer, among other retailer categories; product description information, including searching text provided in the product description (e.g., 100 oz. bottle of sun screen); or a transaction start code, among other preselected digital message trigger data elements. The data in the trigger database 145, including the digital message trigger data elements, may be updated and managed through the information server 120 over a public network, such as the Internet 125, or a private network connection. According to one embodiment, data in the trigger database 145 may be updated and/or managed in real-time. Alternatively, the information server 120 may trigger updates to the trigger database 145 based on system resource availability, such as bandwidth availability or other system availability. The tap device 140 may include a memory device 146 that locally stores data received from the local serve 110, the remote servers and/or other data sources.

According to one embodiment, the processor 143 issues instructions for searching the trigger database entries to find one or more matches between the digital message trigger data elements and the sales transaction data obtained from the POS terminal device 102 during a sales transaction. The processor 143 may identify a match upon detecting one or more of: preselected product details, including a product SKU, among other preselected product details; product description elements, including brand names, product size, product release (e.g., Coca Cola® Classic, 12 oz., 1999 Edition), among other product description elements; quantity purchase amounts (e.g., 6 items); purchase Price (e.g., $2.99) and/or payment information, including cash, credit card issuer (e.g., Visa®, MasterCard®), debit card, among other payment information. The processor 143 may issue instructions to begin searching the trigger database upon detecting: a preselected transaction start code, a preselected category and/or a preselected location of either the retailer or the POS Terminal (Transaction Start Code, category-Convenience Store, location-10010/Manhattan), among other search triggers. The processor 143 may issue instructions for searching the trigger database 145 using a variety of techniques. For example, the processor 143 may issue instructions to search the trigger database 145 using a structured query language (SQL) that uses SQL statements to perform tasks.

The information server 120 may be configured to capture data from sources coupled to the tap device 140, including the POS terminal 102 and the local server 110, among other sources. For sources that require authentication information or security credentials before granting access to the data (e.g., passwords, digital certificates, etc.), the information server 120 may submit authentication information prior to requesting data from the target device, such as the tap device 140. One of ordinary skill in the art will readily appreciate that various authentication schemes may be employed.

During standard operating conditions, the tap device 140 and the local server 110 transmit data to and receive data from the external servers, including the information server 120 and/or the digital message server 122. Under these conditions, the tap device 140 may locally store data received from the internal servers and the external servers, including the information server 120 or the digital message server 122, among other servers. In other words, the tap device 140 may operate as a redundancy device by locally storing data in the memory device 146.

The tap device 140 may include a synchronizing device 147 that maintains data version tags for the data stored at the selected sources and the memory device 146. The data version tags may be used at the selected sources and the memory device 146 to identify the data that is stored most recent in time. According to one embodiment, the synchronizing device 147 may analyze the data version tag and determine whether to replicate data from the selected sources to the memory device 146 or from the memory device 146 to the selected sources. In this way, the synchronizing device 147 prevents the POS terminal 102 from accessing expired data.

For various reasons, the memory device 146 may be accessed or sought to be accessed by local devices, including the POS terminal 102 and the local server 110, among other local devices. As needed, the synchronizing device 147 may update the memory device 146 to include data from the remote servers in order to maintain continuity and timely data. According to one embodiment, the memory device 146 may be updated at selected schedules, including periodic schedules, random schedules, scheduling based on system resources, or other preselected schedules. For example, the memory device 146 may be structured to mirror the data structure of selected sources, such as the local server 110 and remote servers, including the information server 120 and the digital message server 122, among other sources.

Since the memory device 146 stores duplicate up-to-date data, the POS terminal 102 users do not experience a service interruption when internal and/or external communication paths are disrupted. If the memory device 146 includes incomplete data, then any data requests submitted by the POS terminal 102 may be stored in the tap device 140 and propagated to/from the tap device 140 when the selected sources are re-connected to the system. The selected sources may include the local server 110, the information server 120 and the digital message server.

According to one embodiment, data may be retrieved from the memory device 146 during service interruption times. Service interruptions may occur when an internal communication path between the POS terminal 102 and the local server 110 is severed. Alternatively, service interruptions may occur when an external communication path between one of the POS terminal 102 or the local server 110 and the external servers, including the information server 120 or the digital message server 122, are severed. One of ordinary skill in the art will readily appreciate that other service interruption conditions may occur.

The tap device 140 may include a switching device 148 that operates to switch data connections for the POS terminal 102 between selected sources and the tap device 140. The operation of switching the data connection for the POS terminal 102 between the selected sources and the tap device 140 is transparent to users of the POS terminal 102. The switching device 148 may include a detector that determines the communication status of the POS terminal 102. For example, the switching device 148 may detect whether the POS terminal 102 is operating online or offline relative to (1) an internal communication path to the local server 110 and (2) an external communication path to the external sources.

If the POS terminal 102 is determined to be operating offline relative to the external network 125, then the POS terminal 102 may be coupled to one or both of the local server 110 and the tap device 140. If the POS terminal 102 is determined to be operating offline relative to the internal network (e.g., the local server 110), then the POS terminal 102 may be coupled to one or both of the external servers and the tap device 140. Alternatively, the POS terminal 102 may be coupled solely to the tap device 140 during service interruptions.

According to one embodiment, the tap device 140 may be configured to process all types of digital media audio/video files. The digital media audio/video files may include Flash (or “SWF” files); AVI; windows media player (“WMF”) files; static digital images, including JPG, GIF, TIF, etc.; dynamic digital images (animated JPG, GIF, etc.); streaming text files; and streaming video; among other digital media audio/video files. The tap device 140 may include a conversion device 149 that converts the digital media audio/video files to preselected formats prior to storage. According to one embodiment, the digital media audio/video files may be received from the digital message server 122, among other sources.

The processor 143 may instruct the engine 144 to release corresponding digital messages when the processor 143 finds a match between the received sales transaction data and the digital message trigger data elements that are stored in at least one of the information server 120, the local server 110 or the trigger database 145. The digital messages may be release from the digital message server 122 or the memory device 146, among other sources. Any digital messages released from the digital message server 122 may be routed through the information server 120. The digital messages may be delivered to the local server 110 for processing. The local server 110 may direct the digital messages to the POS terminal 102 and/or the tap device 140 for display by the digital displays 108 or the output device, among other devices. If delivered to the POS terminal 102, the digital messages may be displayed to consumers on devices that are communicatively coupled to the POS terminal 102. If delivered to the tap device 140, the digital messages may be displayed to consumers on devices that are communicatively coupled to the tap device 140, but may not be communicatively coupled to the POS terminal 102. According to one embodiment, the digital display 108 may provide a matrix barcode, such as a Quick Response (QR) code, that is scanned by a consumer's smart phone. The QR code may result in delivery of selected content to the consumer's smart phone. Alternatively, the digital message may be delivered to the output device 150, such as a printer or other output device. For example, selected content may be displayed based on finding one or more matches between the digital message trigger data elements and the received sales transaction data, as discussed above.

According to one embodiment, digital messages may include content provided to retail consumers at a check out location. Digital messages may include promotional content, advertising content, news content, weather information, product information, service information, promotional materials, discount information for selected products and services or news related to a specific retailer or retail category, among other digital messages. The digital messages may be delivered and displayed in any form, including digital media audio/video files (SWF, AVI, WMF, etc.), static digital images (JPG, GIF, TIF, etc.), dynamic digital images (animated JPG, GIF, etc.), streaming text files and streaming video.

The tap device 140 may include an updating device 151 that updates the sources, including the local server 110, the information server 120 and the digital message server 122, among other sources. The updating device 151 may modify digital message trigger criteria for presenting the digital messages or content associated with product identification codes, manufacturer information, product quantity amounts, purchase price data, payment method data, total value of the sale data, and transaction location, among other preselected digital message trigger data elements.

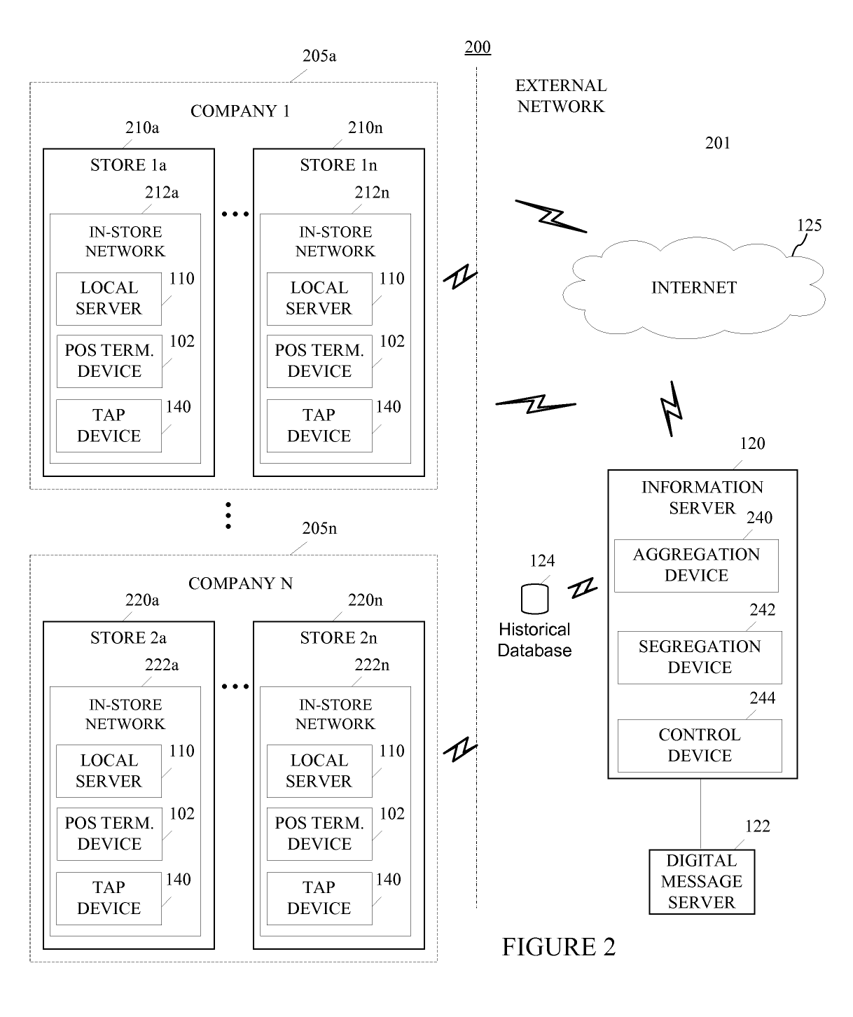

FIG. 2 illustrates exemplary system architecture 200, according to another embodiment of the invention. One or more organizations, such as Company A 205a and Company N 205n, may include a plurality of associated stores. It will be readily understood that “company” may include any organizations having items, such as objects, data, and other items that are intended to be identified collectively. For example, Company A 205a may include a plurality of associated Stores 1a to 1n, identified respectively as 210a-210n. Company N 205n may include a plurality of associated Stores 2a to 2n, identified respectively as 220a-220n. Company A 205a and Company N 205n may include various types of companies, including retail companies, manufacturing companies and entertainment companies, among other company types. Stores 1a to 1n and Stores 2a to 2n may include a plurality of store types, including restaurants, retail stores, among other stores.

According to one embodiment, Stores 1a to 1n and Stores 2a to 2n may have in-store computer networks. For example, Store 1a may include in-store network 212a; Store 1n may include in-store network 212n; Store 2a may include in-store network 222a and Store 2n may include in-store network 222n, among other configurations. The in-store networks illustrated in FIG. 2 include components described above for the in-store network illustrated in FIG. 1. For the sake of brevity, the detailed description of FIG. 2 omits particulars of the digital displays 108, the tap device 140 and the output device 150 described in FIG. 1. One of ordinary skill in the art will readily appreciate that the in-store networks of FIGS. 1 and 2 operate using similar principles.

According to one embodiment, the in-store networks include a POS terminal 102 that is communicatively coupled to one or more local servers 110 and/or to one or more global remote servers, including an information server 120 and a digital message server 122, among other servers. A historical database 124 may be provided to communicate with the remote servers for archiving sales data, among other data. The in-store networks may be communicatively coupled to a plurality of POS terminals 102. The POS terminals 102 may be communicatively coupled to both the corresponding in-store network and to a global external network 201 via a wired network, a wireless network, or a combination of the foregoing and/or other networks, including the Internet 125. The POS terminals 102 may be coupled to an output device 150, such as a printer, imaging device or other output device.

According to one embodiment, the tap device 140 may be positioned between the POS terminal 102 and the output device 150 to monitor and/or capture data passing between these devices, among performing other functions. For example, the tap devices 140 may be positioned between each POS terminal and each output device to monitor and/or capture data passing between these devices. Alternatively, one tap device 140 may be positioned between various POS terminals 102 and output devices 150 to monitor and/or capture data passing between these various devices. The tap devices 140 may operate as unique nodes on the corresponding in-store networks.

The tap devices 140 may be associated with at least one company, including Company A and/or Company N. The tap devices 140 may generate data having header information that includes at least a first unique identifier to associate the data with corresponding stores in which the tap devices 140 are located. The tap devices 140 may further modify the data header information to include at least a second unique identifier that is associated with at least a company that operates or otherwise manages operations of the corresponding tap device 140. One of ordinary skill in the art will readily appreciate that the invention may be implemented using individual identifiers, a single identifier that identifies two or more items, and/or other identifier configurations. Furthermore, the tap devices 140 may modify the data header information to include identifiers associating the tap device 140 with POS terminals 102.

Additionally or alternatively, the tap device 140 may include an automated device that generates identifiers for inclusion in data header information. The identifiers may be affixed to the data header to signify an association between the tap device 140 and one or more of a company, a store and/or POS terminals 102. For example, the tap devices 140 may include a global positioning device that communicates with the processor 143 to generate global positioning data for determining associations between (1) the tap device and the companies, based on a store location, (2) the tap device and the stores, based on a store location, and (3) the tap device and the POS terminals, based on POS terminal location. The tap devices 140 may generate other identifier information to be affixed to the data header. One of ordinary skill in the art will readily appreciate that other techniques may be employed to generate identifier information.

According to one embodiment, the tap devices 140 may capture data obtained from associated POS terminals 102. The tap devices 140 may forward the captured data to the corresponding local server 110 and/or the remote servers, including the information server 120 and the digital message server 121. The remote servers may receive the data captured from tap devices 140 that are located in different stores. The information server 120 may include an aggregation device 240 that aggregates data captured from the tap devices 140 located in different stores that are associated with a same company. Additionally, the remote servers may receive data captured from tap devices 140 located at different stores that are associated with different companies. The captured data includes the unique identifier and identifies at least one store and/or at least one company that are associated with the captured data. The aggregation device 240 merges the captured data into company affiliated data or store data.

The information server 120 may include a segregation device 242 that segregates data captured from the tap devices 140 associated with different companies. Again, the captured data includes the unique identifier and identifies at least one store and/or at least one company that are associated with the captured data. The segregation device 242 separates the captured data into company affiliated data or store data. The segregation device 242 may communicate with the aggregation device 240 to aggregate data received from different stores that are associated with a same company. The information server 120 includes a control device 244 that enables companies to control access to the corresponding company-specific data.

The digital message server 122 delivers digital messages to stores associated with system 200, regardless of a store's company affiliation. To this end, the processor 143 of the tap device 140 may instruct the engine 144 to release corresponding digital messages when the processor 143 finds a match between the received sales transaction data and the digital message trigger data elements that are stored in at least one of the information server 120, the local server 110 or the trigger database 145. The digital messages may be release from the digital message server 122 or the memory device 146, among other sources. Any digital messages released from the digital message server 122 may be routed through the information server 120. The digital messages may be delivered to the local server 110 for processing. The local server 110 may direct the digital messages to the POS terminal 102 and/or the tap device 140 for display by the digital displays 108. If delivered to the POS terminal 102, the digital messages may be displayed to consumers on devices that are communicatively coupled to the POS terminal 102. If delivered to the tap device 140, the digital messages may be displayed to consumers on devices that are communicatively coupled to the tap device 140, but may not be not communicatively coupled to the POS terminal 102. According to one embodiment, the digital display 108 may provide a matrix barcode, such as a Quick Response (QR) code, that is scanned by a consumer's smart phone. The QR code may result in delivery of selected content to the consumer's smart phone. For example, selected content may be displayed based on find one or more matches between the digital message trigger data elements and the received sales transaction data, as discussed above.

According to one embodiment, digital messages may include content provided to retail consumers at a check out location. Digital messages may include promotional content, advertising content, news content, weather information, product information, service information, promotional materials, discount information for selected products and services or news related to a specific retailer or retail category, among other digital messages. The digital messages may be delivered and displayed in any form, including digital media audio/video files (SWF, AVI, WMF, etc.), static digital images (JPG, GIF, TIF, etc.), dynamic digital images (animated JPG, GIF, etc.), streaming text files and streaming video.

The tap device 140 may include an updating device 151 that updates the sources, including the local server 110, the information server 120 and the digital message server 122, among other sources. The updating device 151 may modify digital message trigger criteria for presenting the digital messages or content associated with product identification codes, manufacturer information, product quantity amounts, purchase price data, payment method data, total value of the sale data, and transaction location, among other preselected digital message trigger data elements.

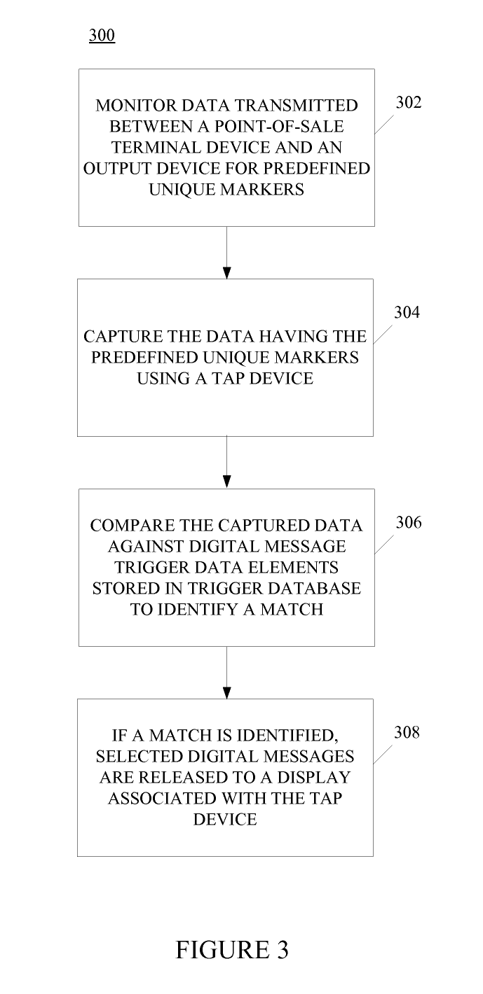

FIG. 3 illustrates a method 300 of automatically delivering digital messages to consumers at the point-of-sale location, without modifying existing point-of-sale systems or electronic cash registers. The method includes monitoring data transmitted between the point-of-service terminal device and an output device for predefined unique markers at step S302. The data having the predefined unique markers is captured using a tap device at step S304. At step S306, the captured data is compared against digital message trigger data elements stored in a trigger database to identify a match between the captured data and the digital message trigger data elements. If a match is identified, selected digital messages are released to a display associated with the tap device in step S308. The selected digital images include a plurality of audio or video file types.

The invention can be realized in hardware, software, or a combination of hardware and software. Any kind of computing system, or other apparatus adapted for carrying out the methods described herein, is suited to perform the functions described herein.

A typical combination of hardware and software could be a specialized computer system having one or more processing elements and a computer program stored on a storage medium that, when loaded and executed, controls the computer system such that it carries out the methods described herein. The invention can also be embedded in a computer program product, which comprises all the features enabling the implementation of the methods described herein, and which, when loaded in a computing system is able to carry out these methods. Storage medium refers to any volatile or non-volatile storage device.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form.

It will be appreciated by persons skilled in the art that the invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A tap device that monitors data communications with a point-of-service terminal device, the tap device being in communication with remote servers that are associated with an external network, a local server that is associated with an internal network and a display for displaying point-of-purchase promotional media, the tap device comprising:
a monitoring device that monitors communication lines of the point-of-service terminal device for data packets having sales transaction data;
a trigger database having entries that include pre-stored digital message trigger data elements;
a processor that communicates with the monitoring device to receive the sales transaction data, the processor generating instructions to search the entries of the trigger database for a match between the pre-stored digital message trigger data elements and the sales transaction data; and
an engine that releases selected digital messages to the display upon receiving a signal from the processor identifying a match.

2. The tap device according to claim 1, wherein the pre-stored digital message trigger data elements include at least one of product identification codes, manufacturer information, product quantity amounts, purchase price data, payment method data, total value of the sale data, transaction location, retailer categories, product description information, and a transaction start code.

3. The tap device according to claim 1, further comprising a memory device that stores data received from remote servers and the local server.

4. The tap device according to claim 3, further comprising a switching device that switches a data connection between the local server, the remote servers and the tap device.

5. The tap device according to claim 1, wherein the digital messages include at least one of promotional content, advertising content, news content, weather information, product information, service information, promotional materials and discount information.

6. The tap device according to claim 1, wherein the engine releases the selected digital messages to the display in real-time upon receiving the signal from the processor identifying the match.

7. The tap device according to claim 3, further comprising a synchronizing device that synchronizes the memory device with at least one of the local server and the remote servers.

8. The tap device according to claim 1, wherein the engine provides a matrix barcode to the digital display.

9. A point-of-sale system provided in an environment having a plurality of stores associated with two or more organizations, the point-of-sale system comprising:
a plurality of in-store networks associated with the plurality of stores and with at least one of the two or more organizations, the plurality of in-store networks comprising:
a tap device that monitors data communications with a corresponding point-of-service terminal device, the tap device assigning a unique identifier to sales transaction data associated with the tap device and the corresponding in-store network;
an information server that communicates with the tap device to obtain the sales transaction data and the unique identifier, the information server comprising:
an aggregation device that aggregates the sales transaction data associated with the two or more organizations based on the unique identifier;
a segregation device that separates the sales transaction data associated with the two or more organizations based on the unique identifier;
a control device that enables the two or more organizations to control access to the corresponding sales transaction data; and
a digital message server that communicates with the information server and the tap device, the digital message server delivering digital messages to the tap device for display to users.

10. The point-of-sale system according to claim 9, wherein the sales transaction data includes at least one of product identification codes, manufacturer information, product quantity amounts, purchase price data, payment method data, total value of the sale data, transaction location, retailer categories, product description information, and a transaction start code.

11. The point-of-sale system according to claim 9, wherein the digital messages include at least one of promotional content, advertising content, news content, weather information, product information, service information, promotional materials and discount information.

12. The point-of-sale system according to claim 9, wherein the tap device is a unique node on the corresponding in-store network.

13. The point-of-sale system according to claim 9, wherein the tap device is associated with one organization.

14. The point-of-sale system according to claim 13, wherein the digital message server delivers the digital messages to the tap device associated with one organization.

15. The point-of-sale system according to claim 9, wherein the tap device is associated with at least two organizations.

16. The point-of-sale system according to claim 15, wherein the digital message server delivers the digital messages to the tap device associated with at least two organizations.

17. A method of automatically delivering digital messages to consumers at a point-of-sale location, without modifying existing point-of-service terminal devices, the method comprising:
monitoring data transmitted between the point-of-service terminal device and an output device for predefined unique markers;
capturing the data having the predefined unique markers using a tap device;
comparing the captured data against digital message trigger data elements stored in a trigger database;
identifying a match between the captured data and the digital message trigger data elements; and
releasing selected digital messages to a display associated with the tap device when the match is identified, the selected digital images including a plurality of audio or video file types.

18. The method according to claim 17, wherein the plurality of audio or video file types include at least one of Flash files, windows media player files, static digital images, streaming text files and streaming video files.

19. The method according to claim 18, further comprising converting the plurality of audio or video file types to preselected formats.

20. The method according to claim 17, further comprising generating a matrix barcode on the display for scanning by a user device.
